(19) United States
(12) Patent Application Publication
(10) Pub. No.: US 2015/0261507 A1
(43) Pub. Date: Sep. 17, 2015

(54) VALIDATING SQL QUERIES IN A REPORT

(71) Applicants: Raghuvira Bhagavan, Bangalore (IN); Subhankar Chattopadhyay, Asta Gharia (IN); Pramod P K, Vaikom (IN); Supriya Thengdi, Nagpur (IN)

(72) Inventors: Raghuvira Bhagavan, Bangalore (IN); Subhankar Chattopadhyay, Asta Gharia (IN); Pramod P K, Vaikom (IN); Supriya Thengdi, Nagpur (IN)

(21) Appl. No.: 14/210,443

(22) Filed: Mar. 14, 2014

(51) Int. Cl. G06F 9/44; G06F 17/30; G06F 3/0484

(52) U.S. Cl. CPC G06F 8/33; G06F 3/04842; G06F 17/30398; G06F 17/30477; G06F 17/30371

(57) ABSTRACT

Various embodiments of systems and methods for validating Structured Query Language (SQL) queries in a software programming language report during application development are described herein. The method involves receiving a selection of a specific SQL query in the report and automatically invoking a data preview editor interface. The selected query is rendered on the interface for execution. In an aspect, the selected query is parsed and a source part and a result part are extracted. Based on the extracted source part and result part, a data type definition and data declaration are automatically determined for the accessed data. Further, a dynamic subroutine is generated with the determined data type definition, data declaration, and the selected query and executed. A preview of the result of executing the dynamic subroutine is rendered in the data preview editor for validating the query.

### FIELD

The subject matter described herein relates to approaches for validating Open Structured Query Language (SQL) queries in a software programming language report during application development.

### BACKGROUND

An integrated development environment (IDE) is computer software that enables computer programmers to develop other software. An IDE typically includes a source code editor, a compiler, an interpreter, build-automation tools, and a debugger. IDE's that are used for developing object-oriented software may also include a class browser, an object inspector, and a class hierarchy diagram. One example of an IDE that may be used to develop object-oriented software is Eclipse. Generally, Eclipse provides various tools and user interfaces (UIs), which are considered to be relatively user-friendly.

A business application may be used to track information that relates to a business by obtaining and integrating finance, sales, and materials data. Specialized programming languages have been developed for writing business applications. One example of such a programming language is the advanced business application programming (ABAP) language. ABAP includes a workbench that offers tools for use in developing business applications. In order to leverage the usability, speed, and flexibility offered by Eclipse, an IDE called “ABAP in Eclipse” has been developed for ABAP development on open Eclipse platform. ABAP in Eclipse is a set of ABAP Development Tools that are designed to combine ABAP application server capabilities with the powerful Eclipse UI and also provide a modern Eclipse UI client on top of the ABAP platform. ABAP Data preview is one of the tools in ABAP in Eclipse that provides a preview of content stored in database tables, e.g., an ABAP data dictionary (DDIC). The ABAP data dictionary contains data describing the logical structure of application development objects and their representations. ABAP developers write Open SQL queries in programs such as an ABAP program or report to read the content of the ABAP data dictionary. The Open SQL queries tend to become very complex even with a few tables and it becomes difficult to validate whether the query is returning the correct result. Conventionally, Application developers resort to debugging to ascertain the correctness of the Open SQL queries. However, in the conventional approach, the debugging process involves the execution of the complete ABAP report involving several steps and long execution time. Further, in order to execute an Open SQL query, the application developer has to write type definitions and data declarations for the output structure for the query results, into which the output of the queries will be fetched.

### SUMMARY

Various embodiments of systems and methods for validating Structured Query Language (SQL) queries in a software programming language report during application development are described herein. In an aspect, the method involves receiving a selection of a specific Open SQL query in the report, where the specific Open SQL query is selected for validation. Further, the method involves automatically invoking a Freestyle Open SQL editor (referred to simply as “data preview editor”) interface and rendering the selected query on the interface. In an aspect, the selected query is parsed in response to receiving an execute command via the interface. Further, a source part and a result part are extracted from the selected query by parsing the selected query. In another aspect, a data type definition and data declaration are automatically determined for the accessed data based on the extracted source part and result part. Further, a dynamic subroutine is generated with the determined data type definition, data declaration and the selected query, and executed. In yet another aspect, a preview of the result of executing the dynamic subroutine for the selected query is rendered in the freestyle data preview editor. The selected query is then validated based on the preview of the query result.

These and other benefits and features of embodiments-will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating elements of exemplary system architecture consistent with implementations of the current subject matter.

FIG. 2 is a flow diagram of a method for validating Open SQL queries in a software programming language report during application development, according to one embodiment.

FIG. 3 is a flow diagram of a method for executing Open SQL queries in a freestyle Open SQL editor, according to one embodiment.

FIGS. 4-6 illustrate an exemplary interface showing freestyle Open SQL editor implementing the current subject matter, in accordance with an embodiment.

FIG. 7 is a block diagram of an exemplary computer system according to one embodiment.

### DETAILED DESCRIPTION

Embodiments of techniques for validating SQL queries in a software programming language report during application development are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Implementations of the current subject matter provide a freestyle Open SQL editor (data preview editor) interface that can be used while writing SQL queries, for application development tasks, in a software programming language, for example, while writing Open SQL queries in Advanced Business Application Programming language (ABAP). The term “Open SQL” as used herein refers to a set of ABAP statements that that are independent of the database system underlying the data being queried thereby allowing the open SQL to have a uniform syntax across different databases. Implementations of the current subject matter can also be used with any database that can be queried by SQL. Consistent with implementations of the current subject matter, application development process can be improved by validating and optimizing the logic in the Open SQL queries instantaneously while creating an ABAP report.

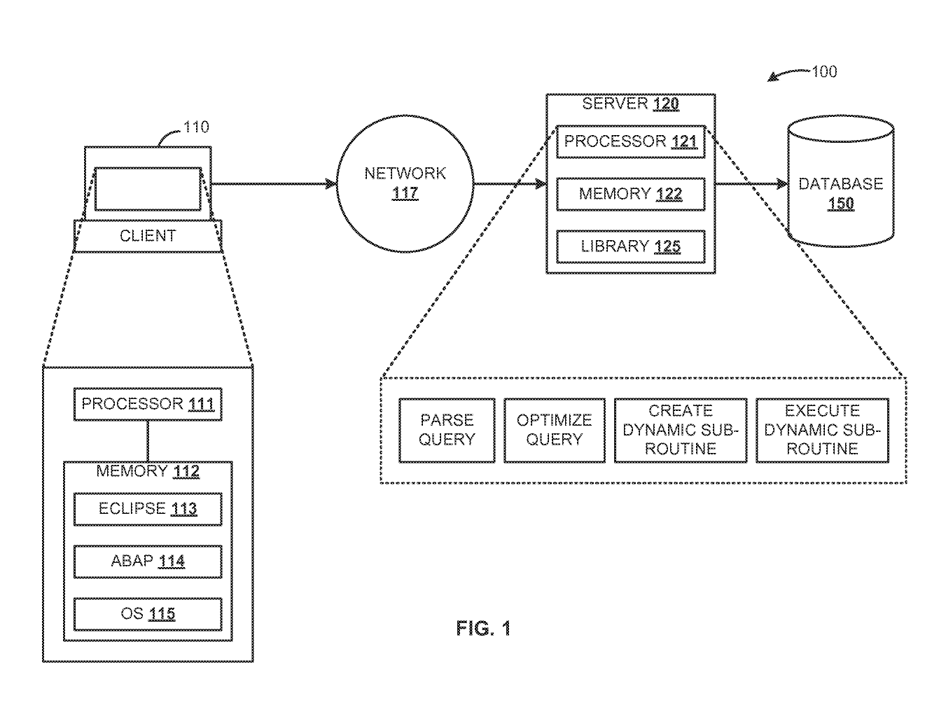

FIG. 1 shows an example of a computer system 100 on which the development environment described herein may be implemented. System 110 includes a front-end component (client 110) and a back-end component (server 120). A network 117 allows front-end and back-end component to communicate and exchange data. The network 117 may include a high-speed data link, such as Ethernet, that connects client 110 to the server 120. The connection may be wired or wireless. The client 110 includes one or more processors (referred to as “processor 111”) and memory 112 that stores instructions that are executable by processor 111. Client 110 may be any type of computing device, such as a desktop computer, a mainframe computer, or the like, that can be used to run an Eclipse environment, and that is capable of obtaining business objects and transmitting those business objects to server 120. Memory 112 also stores an operating system (OS) 115 and instructions for enabling communication between the client 110 and the server 120 and instructions that support use of Eclipse 113 and ABAP 114 on client 110.

Eclipse is an IDE, as noted above, and provides an extensible platform for programmers. Eclipse provides a core of services for controlling a set of tools that work together to support programming tasks. As noted above ABAP is a programming language for use in developing business applications. ABAP Development Tools i.e., ABAP in Eclipse provide for development tasks in Eclipse platform. Back-end component (or an associated repository) stores an ABAP dictionary in library 125. The ABAP dictionary contains data describing the logical structure of application development objects and their representations. ABAP runtime environment components, such as application programs (Report) or a database interface, obtain information about these objects from the ABAP dictionary. Computer programs on the client 110 make use of information from the ABAP dictionary during application development. These include an Eclipse program 112, and an ABAP program 113 for supporting ABAP programming on client 110.

The ABAP workbench contains a toolset that enables developers to customize and extend existing applications or create new applications. ABAP is keyword-oriented, meaning that a keyword is the first word in an ABAP statement, and determines the meaning of the entire statement. For example, there are four different types of ABAP keywords: declarative, event, control, and operational keywords. Typically, these keywords precede a corresponding statement.

Server 120 may be any type of computing device that is capable of receiving and storing data, and of communicating with client 110. As shown in FIG. 1, server 120 includes one or more processors (referred to simply as “processor 121”) and memory 122 that stores computer programs that are executable by processor 121. The computer programs include instructions for accessing library 125, e.g., for retrieving an object from the library and for sending an object to the library. Library 125 may be stored in the back-end component 120 or in a separate repository 150 that is accessible to the back-end component 120 over a bus or network connection. Further, the processor 121 includes a parser implementation that parses an Open SQL query, optimizes the query, creates dynamic sub-routine based on the parsing, executes the dynamic subroutine, and provides a preview of the query result.

The ABAP dictionary (DDIC) in library 125 centrally describes and manages the data definitions used in the system. Data definitions (metadata) are created and managed in the ABAP Dictionary. The ABAP Dictionary permits a central description of the data used in the system without redundancies. Using these data definitions, a programming entity can create corresponding objects (tables or views) on the underlying relational database The ABAP Dictionary therefore describes the logical structure of the objects used in application development and shows how they are mapped to the underlying relational database in tables or views. Some of the object types in the ABAP Dictionary are tables, database views, types, domains, search helps and lock objects. Tables are defined in the ABAP dictionary independently of the database. A table having the same structure is then created from this table definition in the underlying database. In the ABAP dictionary, a database view (referred to as an ABAP dictionary view) is a logical view on more than one table, i.e., a view is derived from one or more other tables. The structure of the view is defined in the ABAP Dictionary. A view on the database can then be created from this structure.

Typically, ABAP developers write Open SQL queries in ABAP programs (report) to read the content of the ABAP Dictionary. In an embodiment, a freestyle data preview editor is provided that could provide an instant preview of the content stored in the ABAP Data Dictionary. The term “instant” as used herein refers to an immediate point in time. In this embodiment, the ABAP developers can write an Open SQL query in the data preview editor interface and execute the query to determine whether the Open SQL query returns the correct result or not. ABAP developers may also optimize the existing queries using the data preview tool.

In an aspect, the data preview editor is launched from a content menu of a DDIC table or View. In an embodiment, the data preview editor interface has two distinct sections namely, a text area where free text (Open SQL query) can be typed into and a preview area where a preview of the query results is rendered. The data preview editor provides a parser implementation that provides code completion (content assist) and error marking features in addition to query parsing. In an embodiment, the parser reads a file containing grammar for the Open SQL query such as a PAD (Portable Application Description) file. For example, the PAD file may be generated for the SELECT statement syntax and maybe downloaded from the back-end to the front-end (client). One of the features of the parser implementation is auto completion (statement continuation/semantic code completion) of function calls. Auto completion is a feature that provides one or more pop-up windows listing possible completions for “initiating” strings that a user has typed. An initiating string may be a programming language keyword or identifier, such as an ABAP keyword. The parser also provides Error Marker (Syntax coloring) feature for automatically checking the correctness of the syntax for the Open SQL statements and highlighting the syntax errors. The parser implementation provides for query parsing in the front-end to separate the ABAP statement in the query into tokens and determining a type of the tokens (e.g., identifier, keyword, or operator).

In an aspect, the Open SQL query that is constructed in the data preview editor is executed in the ABAP application server. The data preview editor is communicatively connected to the ABAP application server via the ABAP Development Tool (ADT) resource framework. In an example, the SELECT statement is used to query the database and retrieve selected data that match the criteria that is specified in the query. The syntax of Open SQL SELECT statement in the data preview editor is shown in the following example:

SELECT result

FROM source
INTO APPENDING target
[[FOR ALL ENTRIES IN itab] WHERE sql_cond]
[GROUP BY group] [HAVING group_cond]
[ORDER BY sort_key]

...
[ENDSELECT]

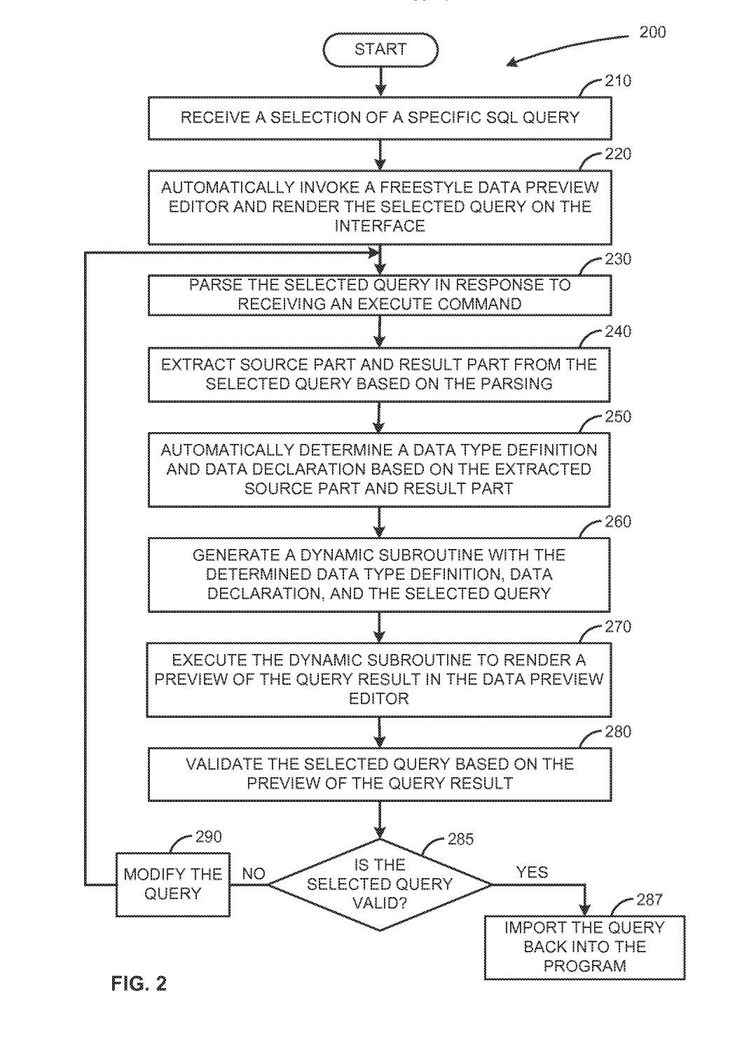

As shown in the example above, the correct syntax for the SELECT statement in the data preview editor requires an ‘INTO’ clause. Typically, a local work space that is type compatible with the result of the query is declared and used for storing the result of the query. However, in the freestyle Open SQL editor, the user is not required to enter type definitions and data declaration for the result set returned by the query. The data type definitions and data declaration for the result set are automatically generated by the parser provided by the data preview editor. The method of generating the type definitions and data declarations and executing the Open SQL query in the data preview editor is described with reference to FIG. 2.

FIG. 2 shows a flow diagram illustrating a method for validating SQL queries in a software programming language program during application development. In an embodiment, the method is implemented for validating Open SQL queries in ABAP report during application development. The method involves receiving a selection of a specific Open SQL query in the program (report) at process block 210. For example, a user may select a query or a set of queries from the report to validate the correctness of the report. i.e., to determine whether the selected query returns the expected results. In another embodiment, a user may type/enter/paste a query directly into the text area of the data preview editor interface. At process block 220, in response to receiving the selection of the specific query, a data preview editor is automatically invoked and the selected query is rendering on the interface. In an aspect, the selected query is rendered in a text area of the data preview editor interface. The query rendered on the interface may be edited/modified if needed prior to execution. In an aspect, the query may be executed upon receiving a command for execution via the interface. For example, a user may select an ‘Execute’ option on the interface in order to run the query. Alternatively, the query may be automatically executed in the data preview editor interface subsequent to receiving a selection of the query in the report. In either case, at process block 230, in response to receiving the execute command via the interface the parser implementation parses the rendered query. Further, at process block 240, a source part and a result part are extracted from the selected query based on the parsing. Based on the extracted source part and result part, at process block 250, a data type definition and data declaration for the accessed data are automatically determined.

Further, at process block 260, a dynamic subroutine is generated with the determined data type definition, data declaration, and the selected query. The term “dynamic subroutine” as used herein refers to a report program that is created during runtime and then executed. At process block 270, the generated dynamic subroutine is executed. In yet another aspect, a preview of the result of executing the dynamic subroutine for the selected query is rendered in the data preview editor. At process block 280, the selected query is validated based on examining the preview of the query result. Upon examining the query result, if it is determined, at process block 285, that the selected query is incorrect, or that the selected query returned unexpected results, then the selected query is modified in the text area of the data preview editor interface, at process block 290. The steps of the process blocks 230-280 are repeated on the modified query until the query is determined to be valid at process block 285. The valid query is then imported back into the report, at process block 287. In an aspect, after importing the query back into the report, the ABAP developer does not have to make any changes in the ABAP report to run the report. The requisite data type definitions are automatically pasted into the report and the ABAP report is rendered executable.

Since the data preview editor provides a parser implementation that automatically derives the data type definition and data declaration for the result of the query, the user is not required to enter type definitions and data declarations for the Open SQL Query in the data preview editor interface. In the embodiment, where the user directly selects the query from the report for previewing the results in the data preview editor, the user does not have to make any changes to the query in the data preview editor to run the query. The selected query is immediately executable as rendered in the editor interface. Any data type definition and declaration necessary to run the query is handled internally and transparently by the data preview editor. In an aspect, the parser separates the ABAP statement into tokens and classifies the tokens into keyword, identifier, operator, etc. Further, in order to implement an output structure for the query results, the tables/views accessed by the query is identified by parsing the Open SQL query with standard string manipulation functionalities provided by ABAP. In another aspect, query execution in a database may include authority checks in order to circumvent any possibility of malicious code injection as the query is passed from the client to the server. In an example, only users with sufficient authorization will be allowed to invoke the freestyle Open SQL editor by the ADT framework. In addition, only users having authorization may access the tables/views mentioned in the query.

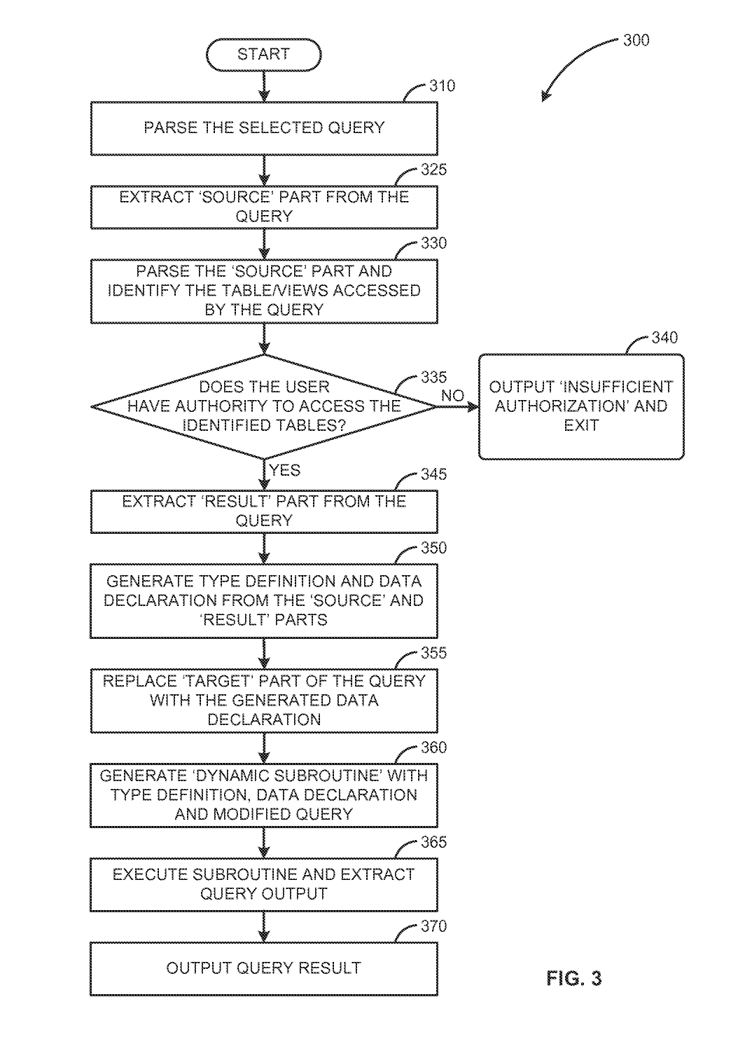

The method of parsing the query and automatically determining the data type definition and data declaration is described with reference to the process flow diagram in FIG. 3. At process block 310, the parser implementation parses the query rendered in the editor interface upon receiving an execute command. At process block 325, a ‘Source’ part of the query is extracted and at process block 330, the ‘Source’ part is parsed and the table(s)/view(s) accessed by the query is identified. At block 335, it is determined whether the user has sufficient authorization to access the identified tables or views. If it is determined that the user does not have the authorization to access the tables/views, then a notification message such as “Insufficient authorization” is output at process block 340 and the execution is stopped. On the other hand, if it is determined that the user has sufficient authorization to access the identified tables/views, then the execution proceeds to process block 345 where a ‘Result’ part of the query is extracted.

At process block 350, a data type definition and data declaration is generated based on the ‘Source’ and ‘Result’ parts. Further, at process block 355, the ‘Target’ part of the query is replaced with the generated data declaration. In an embodiment, in order to limit the results of the query in the case where the query does not specify a row limit, a ‘TOP’ part of the query may be replaced with a predefined row limit. Also, in the case where the query does not include a ‘TOP’ part, the query may be appended with a ‘TOP’ part having a predefined row limit. Subsequently, at process block 360, a ‘Dynamic Subroutine’ is generated using the type definition, data declaration and the modified query. The generated Dynamic Subroutine is executed and the output of the query is extracted, at process block 365. At process block 370, the query result is rendered in the preview section of the data preview editor interface.

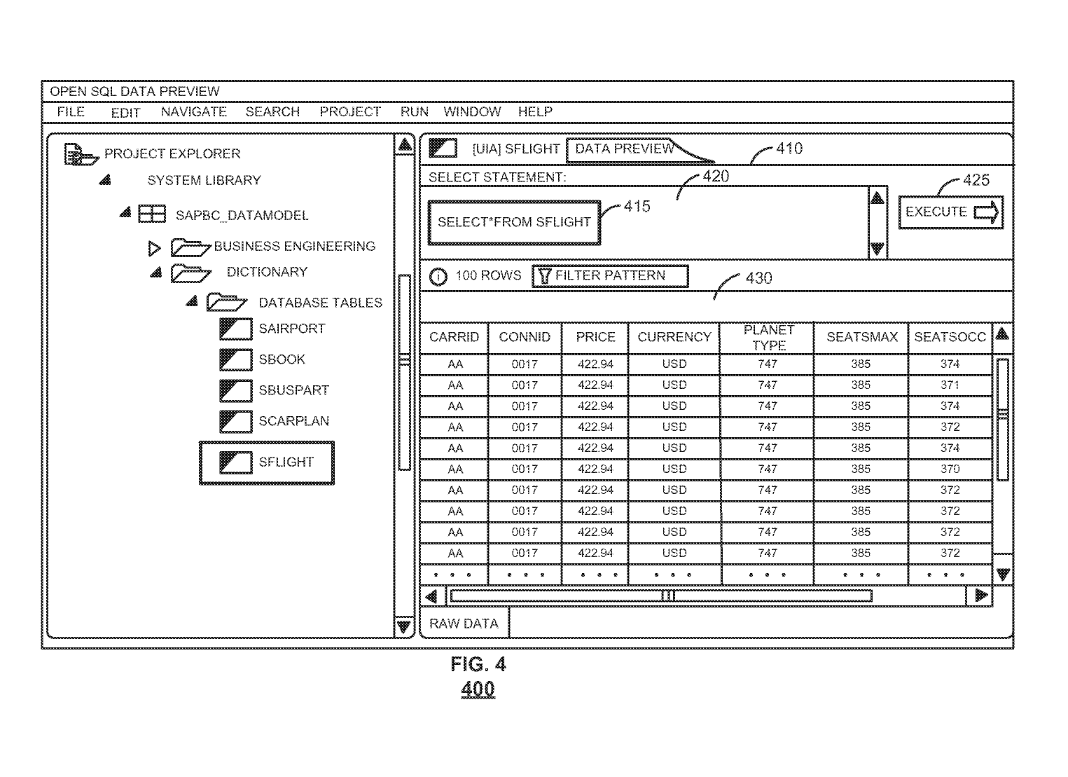

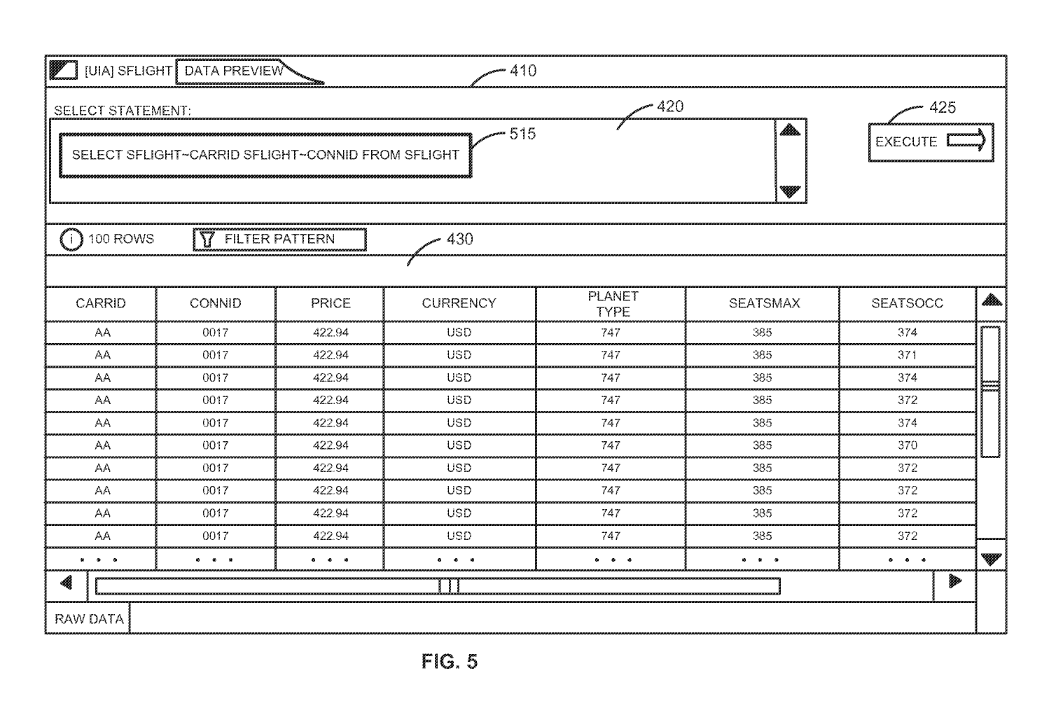

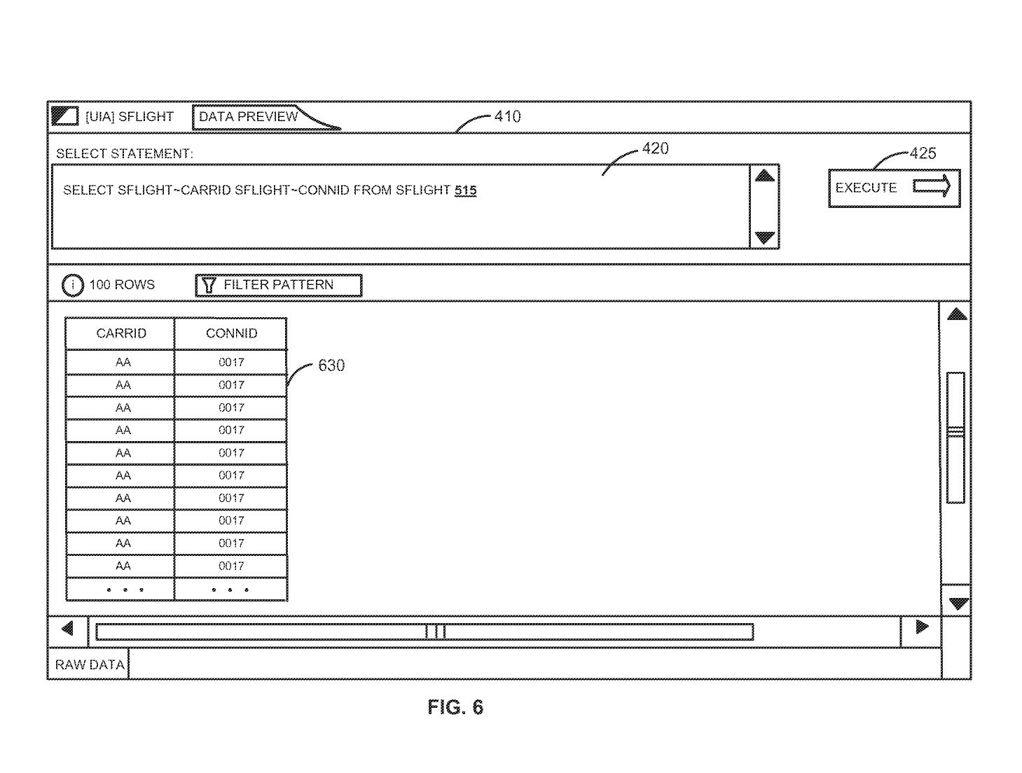

In an example scenario, an ABAP developer is creating an ABAP report containing open SQL queries. The ABAP developer may want to verify the correctness of a specific query. At this point, executing the complete ABAP report would involve several steps with an execution time spanning several minutes. However, according to the implementations of the current subject matter, the ABAP developer may simply copy the Open SQL query from the ABAP report and paste it into the freestyle Open SQL editor interface. Alternatively, as discussed above, the developer may simply select the query and invoke the data preview editor. In either case, the query is rendered in the data preview editor interface where the query can be executed. For example, as shown in FIG. 4, the selected query 415 is rendered in a text area 420 of the data preview editor interface 410. The developer may then run the query to preview the results of the query. For example, the developer may press an “Execute” option 425 on the interface 410 to preview the results of the query. Note that the ABAP developer does not have to make any changes to the query in the data preview editor to run the query. The selected query is immediately executable as rendered in the editor interface 410. Any data type definition and declaration necessary to run the query is handled internally and transparently by the freestyle Open SQL editor 400. Upon execution of the query in the data preview editor 400, the results of the query are rendered in the preview area 430 of the data preview editor interface 410. The ABAP developer may review the results returned by the query and change/tweak/modify/optimize/improve the query and repeatedly run the query in the data preview editor until the query returns the expected results. As shown in the example in FIG. 5, the query 415 (FIG. 4) may be modified to query 515 and executed. The developer may then verify the results 630 (shown in FIG. 6) of the modified query 515 and validate the query. This process may be repeated iteratively until the query returns the results expected by the developer. Once the ABAP developer arrives at the correct query, he/she may copy the query and paste it back into the ABAP report. After importing the query back into the report, the ABAP developer does not have to make any changes in the ABAP report to run the report. The requisite data types are automatically pasted into the report and the ABAP report is rendered executable. In the example below, copying the query Q1 from the data preview editor into the report will automatically render the query Q2 with the requisite data types,

| | |
|---|---|
| select * from [TABLE] | → Q1 |
| data [ABAP_DATA] type table of [TABLE] | → Q2 |
| select * from [TABLE] | |
| INTO [ABAP_DATA] | |

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

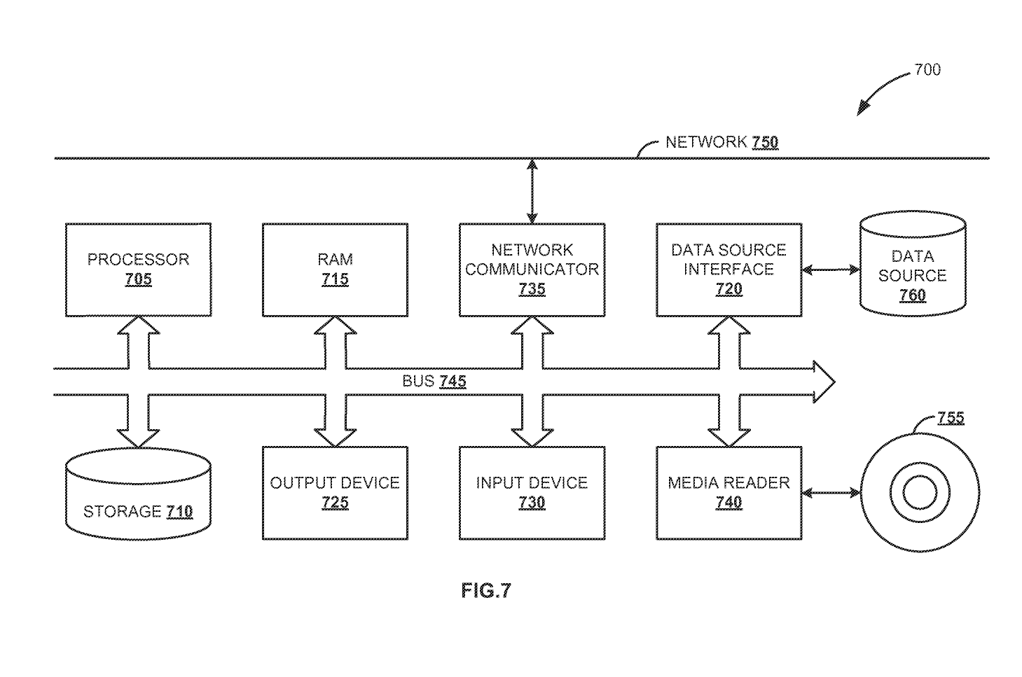

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the invention one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer-implemented method for validating Structured Query Language (SQL) queries in a software programming language program during application development, comprising:
receiving a selection of a specific SQL query in the program;
automatically invoking a data preview editor interface and rendering the selected query on the interface;
in response to receiving an execute command, parsing the selected query;
extracting a source part and a result part from the selected query;
automatically determining a data type definition and data declaration based on the extracted source part and result part;
generating a dynamic subroutine with the determined data type definition, data declaration, and the selected query;
executing the dynamic subroutine to render a preview of query result in the data preview editor interface; and
validating the selected query based on the preview of the query result.

2. The method of claim 1 further comprising:
validating the selected query by assessing the query result rendered in the preview;
upon determining that the rendered query result is inaccurate, modifying the selected query;
executing the modified query for validating the modified query; and
iteratively modifying the selected query until a result of executing the modified query, rendered in the preview, is accurate.

3. The method of claim 2, further wherein,
upon determining that the modified query is valid, copying the modified query back into the program; and
automatically provisioning data type definitions and data declarations for the modified query in the program for execution.

4. The method of claim 1, wherein automatically generating the data type definition and the data declaration further comprises:
identifying one or more tables accessible by the selected query based on the source part; and
determining that a user has authority to access the one or more tables prior to generating the dynamic subroutine.

5. The method of claim 1, further comprising:
determining whether the selected query includes an ‘INTO’ part; and
upon determining that the selected query includes the ‘INTO’ part, replacing the ‘INTO’ part in the query with the generated data declaration.

6. The method of claim 1, further comprising:
determining whether the selected query includes a ‘TOP’ part;
upon determining that the selected query includes the ‘TOP’ part, replacing the ‘TOP’ part in the query with a predefined row limit;
upon determining that the selected query does not include the ‘TOP’ part, appending the ‘TOP’ part to the selected query with the predefined row limit.

7. A computer program product comprising a non-transitory machine-readable medium storing instructions that, when executed by at least one programmable processor, cause the at least one programmable processor to perform operations comprising:
receiving a selection of a specific SQL query in a software programming language program;
automatically invoking a data preview editor interface and rendering the selected query on the interface;
in response to receiving an execute command, parsing the selected query;
extracting a source part and a result part from the selected query;
automatically determining a data type definition and data declaration based on the extracted source part and result part;
generating a dynamic subroutine with the determined data type definition, data declaration, and the selected query;
executing the dynamic subroutine to render a preview of query result in the data preview editor interface; and
validating the selected query based on the preview of the query result.

8. The computer program product of claim 7, wherein the operations further comprise:
validating the selected query by assessing the query result rendered in the preview;
upon determining that the rendered query result is inaccurate, modifying the selected query;
executing the modified query for validating the modified query; and
iteratively modifying the selected query until a result of executing the modified query, rendered in the preview, is accurate.

9. The computer program product of claim 8, wherein the operations further comprise:
determining that the modified query is valid;
copying the modified query back into the program; and
automatically provisioning data type definitions and data declarations for the modified query in the program for execution.

10. The computer program product of claim 7, wherein automatically generating the data type definition and the data declaration further comprises:
identifying one or more tables accessible by the selected query based on the source part; and
determining that a user has authority to access the one or more tables prior to generating the dynamic subroutine.

11. The computer program product of claim 7, wherein the operations further comprise:
determining whether the selected query includes an ‘INTO’ part; and
upon determining that the selected query includes the ‘INTO’ part, replacing the ‘INTO’ part in the query with the generated data declaration.

12. A computer program product as in claim 7, wherein the operations further comprise:
determining whether the selected query includes a ‘TOP’ part;
upon determining that the selected query includes the ‘TOP’ part, replacing the ‘TOP’ part in the query with a predefined row limit;
upon determining that the selected query does not include the ‘TOP’ part, appending the ‘TOP’ part to the selected query with the predefined row limit.

13. A system comprising:
at least one programmable processor; and
a machine-readable medium storing instructions that, when executed by the at least one programmable processor, cause the at least one programmable processor to perform operations comprising:
receiving a selection of a specific SQL query in a software programming language program;
automatically invoking a data preview editor interface and rendering the selected query on the interface;
in response to receiving an execute command, parsing the selected query;
extracting a source part and a result part from the selected query;
automatically determining a data type definition and data declaration based on the extracted source part and result part;
generating a dynamic subroutine with the determined data type definition, data declaration, and the selected query;
executing the dynamic subroutine to render a preview of query result in the data preview editor interface; and
validating the selected query based on the preview of the query result.

14. The system of claim 13 wherein the data preview editor interface comprises a text area for receiving SQL queries and a preview area for rendering query results.

15. The system of claim 13, wherein the software programming language comprises an advanced business application programming (ABAP) language.

16. The system of claim 13, wherein the selected SQL query is an Open SQL query.

17. The system of claim 13, wherein the data preview editor interface further comprises a user-selectable option for executing the selected query.

18. The system of claim 13, wherein the data preview editor interface further comprises a filter for filtering the query result.
